(19) United States
(12) Patent Application Publication
(10) Pub. No.: US 2010/0085439 A1
(43) Pub. Date: Apr. 8, 2010

(54) IMAGE CAPTURE DEVICE AND METHOD THEREOF

(75) Inventor: Cing-Shin Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/412,379

(22) Filed: Mar. 27, 2009

(30) Foreign Application Priority Data
Oct. 6, 2008 (CN) 200810304751.7

(51) Int. Cl. H04N 5/228

(52) U.S. Cl. 348/222.1; 348/E05.031

(57) ABSTRACT

An exemplary image capture device includes a camera module, a buffer including a first unit and a second unit, a processor, and a memory. The camera module is configured for capturing images by forming corresponding electric signals. The first unit of the buffer is configured for buffering electric signals formed in a period that the image capture device is used to preview before capturing. The second unit of the buffer is configured for buffering electric signals formed after the image capture device is fired to photograph. The processor is configured for processing the electric signals in the first unit into preview digital images when preview, and processing the electric signals in the second unit and those still buffered in the first unit into final digital images after the image capture device is fired. The memory is configured for storing the final digital images outputted from the processor.

### BACKGROUND

1. Technical Field

The present disclosure relates to image capture devices and, particularly, to an image capture device capable of capturing images of an instant scene and an image capture method thereof.

2. Description of Related Art

When capturing consecutive images, a user generally points an image capture device to an object and then presses a shutter release key to fire the image capture device. Due to human reaction time and the delay between the pressing of the shutter release key and the photographing of the image capture device, it is difficult for the user to capture desirable consecutive images of some instant scenes using the image capture device.

Therefore, it is desirable to provide an image capture device and method thereof, which can overcome the described limitations.

### BRIEF DESCRIPTION OF THE DRAWINGS

FIG. 1 is a block diagram of a digital image capture device in accordance with an embodiment of the disclosure.

FIG. 2 is a flowchart of an image capture method, according to another embodiment.

### DETAILED DESCRIPTION

Embodiments of the disclosure will now be described in detail with reference to the drawings.

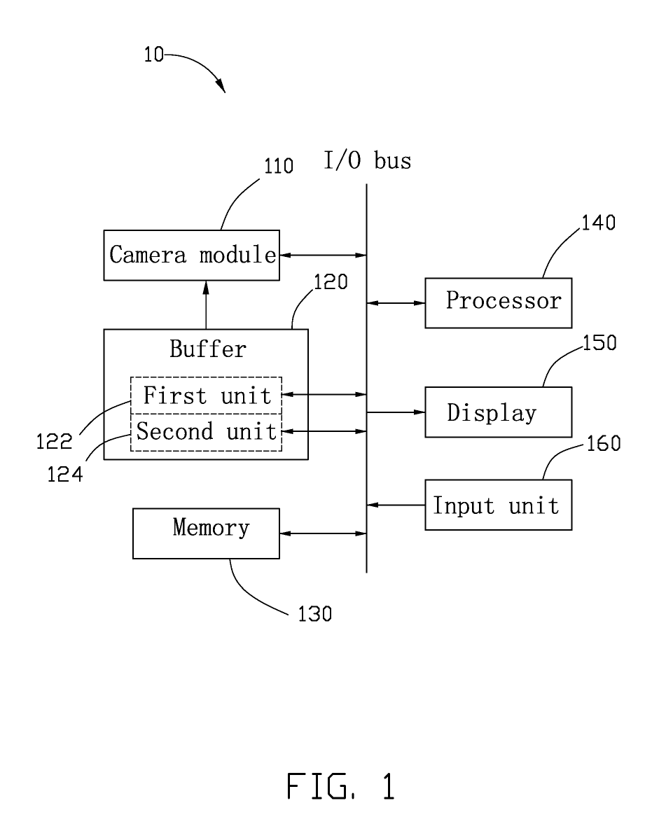

Referring to FIG. 1, an image capture device 10 in accordance with an exemplary embodiment includes a camera module 110, a buffer 120, a memory 130, a processor 140, a display 150, and an input unit 160. In this embodiment, the image capture device 10 is a digital video camera, although any other image capture device such as a cellular phone having a camera module is equally applicable while remaining well within the scope of the disclosure.

The camera module 110 includes a lens and an image sensor (not shown). The lens is configured for forming an optical image on the image sensor. The image sensor, such as a charge coupled device (CCD), is configured for converting the optical image signals into corresponding digital images. In practice, the camera module 110 forms electric signals corresponding to the digital images. The camera module 110 is continuously focused using corresponding software modules executed in the processor 140.

The buffer 120 includes a first unit 122 and a second unit 124, and is configured for buffering electric signals being processed for the image capture device 10. The first unit 122 has a pre-determined capacity to store the digital images consecutively outputted from the camera module 110, when using the image capture device 10 to preview images before capturing. The first unit 122 keeps updating (i.e., dynamically buffering) the digital images in a first-in first-out (FIFO) manner. In this embodiment, the camera module 110 forms digital images at a rate of 30 images per second. The first unit 122 has a capacity to store the digital images formed by the camera module 110 in about three seconds. Accordingly, the digital images formed within about three seconds are still stored in the first unit 122 at the moment that the images are finally captured. The second unit 124 is configured for buffering final digital images outputted from the camera module 110 after the image capture device 10 is operated by the user to finally capture the images.

The memory 130 is configured for storing the final digital images formed by the camera module 110.

The processor 140 is configured for processing the electric signals outputted from the camera module 110, and finally outputting corresponding digital images to the memory 130 and/or the display 150. In particular, the processor 140 may perform various signal processes, such as color space converting, gamma correcting, and encoding, on the electric signals. When using the image capture device 10 to preview, the processor 140 processes the electric signals in the first unit 122, and then outputs preview digital images to the display 150. Generally, the preview digital images are processed, e.g., encoded, into video signals. When using the image capture device 10 to photograph, the processor 140 processes the electric signals in the second unit 124 and those still buffered in the first unit 122, and outputs final digital images to the memory 130 and/or the display 150. In this embodiment, the final digital images are also processed into video signals. The processor 140 is programmed to firstly process the electric signals in the first unit 122 and then the second unit 124.

The display 150 such as a liquid crystal display is configured for displaying digital images and interactive information for a user. The input unit 160 such as a keypad is configured for receiving inputs of the user. The display 150 and the input unit 160 constitute a user interface of the image capture device 10. In other alternative embodiments, the display 150 and the input unit 160 can be integrated into a touch-screen.

The image capture device 10 buffers preview digital images formed within a latest pre-determined period such that some missed instant scenes can be retrieved from the buffered digital images. Therefore, the image capture device 10 is capable of capturing images of instant scenes.

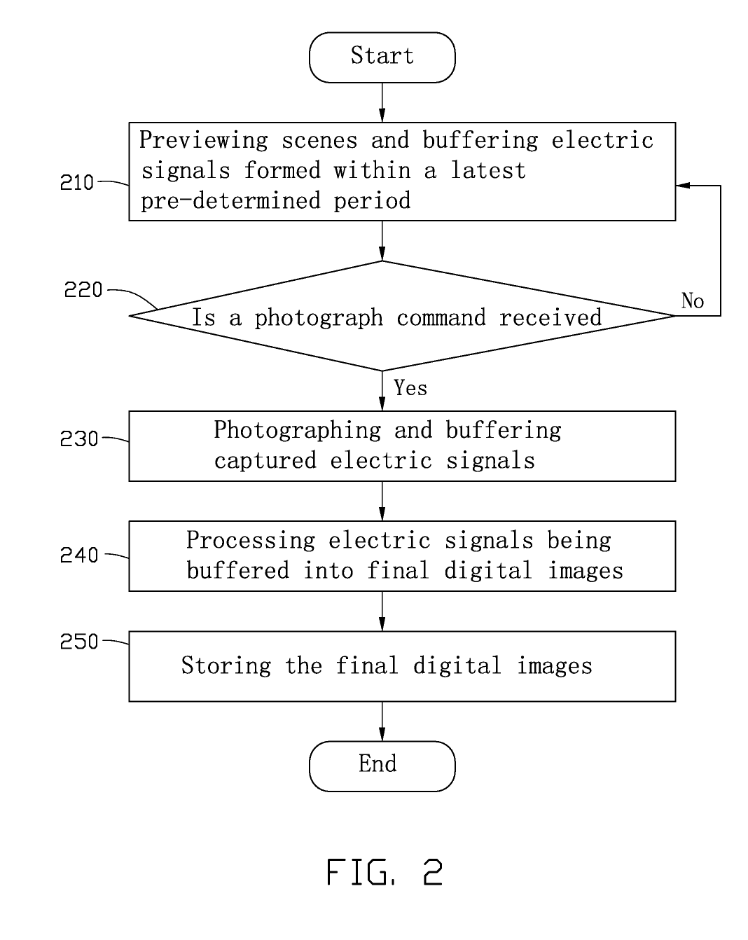

Referring to FIG. 2, an image capture method, according to another embodiment, can be exemplarily implemented by the image capture device 10 and includes the following steps 210-250.

Step 210: Previewing scenes and buffering electric signals formed within a latest pre-determined period. In detail, the image capture device 10 is shot to preview scenes, and the camera module 110, continuously focused, forms corresponding electric signals. The electric signals are buffered in the first unit 122, processed into preview digital images in the processor 140, and finally displayed in the display 150 for preview. In this embodiment, the electric signals are updated in a FIFO manner, such that the latest electric signals formed within about three seconds are stored in the first unit 122.

Step 220: Judging if a photograph command is received from the user. If yes, go to Step 230. If no, go back to Step 210. In detail, the processor 140 keeps detecting if a photograph command is inputted from the input unit 160 by operations of a user. In practice, pressing a shutter release key implies a photograph command.

Step 230: Photographing and buffering captured electric signals. In detail, the image capture device 10 is fired to photograph, and the camera module 110 forms corresponding electric signals. The electric signals are buffered in the second unit 124.

Step 240: Processing electric signals formed at photographing and that formed within the latest pre-determined period before photographing into final digital images. In detail, at the beginning of photographing, a pre-determined capacity of electric signals formed at previewing are still buffered in the first unit 122. The processor 140 processes the electric signals being buffered by the first unit 122 and the second unit 124 into final consecutive digital images. Thereby, the electric signals formed at previewing forms part of the final images. The processor 140 is programmed to firstly process the electric signals in the first unit 122 and then the second unit 124. In this embodiment, the electric signals are processed into video signals.

Step 250: Storing the final digital images. In detail, the final digital images are stored into the memory 130.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of arrangement of parts within the principles of the invention to the full extent indicated by the broad general meaning of the terms in which the appended claims are expressed.

What is claimed is:

1. An image capture device, comprising:
a camera module configured for capturing images by forming corresponding electric signals;
a buffer comprising:
a first unit configured for buffering electric signals formed in a period that the image capture device is used to preview images before capturing; and
a second unit configured for buffering electric signals formed after the image capture device is fired to photograph;
a processor configured for processing the electric signals in the first unit into preview digital images when preview, and processing the electric signals in the second unit and those still buffered in the first unit into final digital images after the image capture device is fired; and
a memory configured for storing the final digital images outputted from the processor.

2. The image capture device of claim 1, wherein the first unit has a pre-determined capacity, and is capable of keeping updating the stored electric signals in a first-in first-out manner.

3. The image capture device of claim 2, wherein the first unit has a capacity to store the electric signals formed within about three seconds before the image capture device is fired to photograph.

4. The image capture device of claim 1, wherein the processor is programmed to firstly process the electric signals in the first unit and then the second unit.

5. The image capture device of claim 1, wherein the electric signals are processed into video signals.

6. The image capture device of claim 1, wherein the camera module is continuously focused using corresponding software modules executed in the processor.

7. The image capture device of claim 1, further comprising:
a display configured for displaying images and interactive information for a user; and
an input unit configured for receiving inputs of the user.

8. An image capture method, comprising:
previewing scenes and buffering electric signals formed within a latest pre-determined period;
photographing and buffering captured electric signals after a corresponding command is received;
processing electric signals formed at photographing and those formed within the latest pre-determined period before photographing into final digital images; and
storing the final digital images.

9. The image capture method of claim 8, wherein the electric signals are updated in a first-in first-out manner when preview.

10. The image capture method of claim 8, wherein the electric signals are processed into preview digital images in the previewing step.

11. The image capture method of claim 8, wherein the electric signals formed at previewing are firstly processed.

12. The image capture method of claim 8, wherein the electric signals are processed into video signals.

13. The image capture method of claim 8, wherein at the step of previewing scenes and buffering electric signals formed within a latest pre-determined period, the scenes are continuously focused.

14. The image capture method of claim 8, further comprising:
repeating previewing scenes and buffering electric signals formed within a latest pre-determined period if no corresponding command is received.
